(19) United States
(12) Patent Application Publication
(10) Pub. No.: US 2024/0331016 A1
(43) Pub. Date: Oct. 3, 2024

(54) METHOD OF GUIDING A PERSON TO PRODUCTS

(71) Applicant: VusionGroup GmbH, Fernitz-Mellach (AT)

(72) Inventors: Tarik FILALI ANSARY, Fernitz-Mellach (AT); Andreas RÖSSL, Fernitz-Mellach (AT); Philippe BOTTINE, Fernitz-Mellach (AT); Francois Xavier GENDRIN, Fernitz-Mellach (AT)

(73) Assignee: VusionGroup GmbH, Fernitz-Mellach (AT)

(21) Appl. No.: 18/575,432

(22) PCT Filed: Jul. 2, 2021
(86) PCT No.: PCT/EP2021/068332

§ 371 Date: Dec. 29, 2023

(51) Int. Cl. G06Q 30/0601; H04W 4/024

(52) U.S. Cl. CPC G06Q 30/0639; H04W 4/024

(57) ABSTRACT

A method of guiding a person to products, wherein the method comprises the following steps, namely: emitting a radio beacon from a radio beacon emitter, which is assigned to a product and is essentially located in the spatial proximity of this product or the intended place of the product, receiving the emitted radio beacon by a radio beacon receiver which is locally movable with the person, triggering an action when the radio beacon receiver is moved into a predefined action-triggering area around the radio beacon emitter.

### TECHNICAL FIELD

The invention relates to a method of guiding a person to products, which in particular is applied in an order picking system which guides an order picker.

### BACKGROUND

Nowadays, many supermarkets offer their customers a so-called “pick & collect service”. Customers can therefore place their orders and the goods are collected in the supermarket by an employee (called order picker in technical jargon) and prepared for the customer to be ready for collection. To assemble the ordered goods for the customer, the order picker moves through the store with his/her personal digital assistant (PDA), which is used to display the order, and picks the relevant products directly from the shelves. All electronic labels (ESLs) installed at positions of products to which the ESLs are logically linked support the order picker by an action which is flashing a light diode of the ESLs. The flashing light diodes lead the order picker to the products which shall be picked.

However, this means that sometimes a very large number of ESLs must flash simultaneously and for long periods of time until the products in question have been collected and the order picker acknowledges this and the ESL in question stops flashing.

However, this is accompanied by a considerable energy consumption, which is noticeable not only in battery-operated ESLs where the lifetime of the battery is significantly reduced but also in power supply-operated ESLs.

Therefore, the object of the invention is to provide an improved method of guiding a person to products and an improved system, by which the improved method is performed, so that the problems discussed above are overcome.

### SUMMARY OF THE INVENTION

This object is achieved by a display-system according to claim 1. Therefore, the subject matter of the invention is a method of guiding a person to products, wherein the method comprises the following steps, namely emitting a radio beacon from a radio beacon emitter, which is assigned to a product and is essentially located in the spatial proximity of this product or the intended place of the product, receiving the emitted radio beacon by a radio beacon receiver which is locally movable, in particular with the person or a device, triggering an action when the radio beacon receiver is moved into a predefined action-triggering area around the radio beacon emitter.

The measures according to the invention provide the advantage that the appearance of the action, which lead to energy consumption of the system, is depended on the relative position of the radio beacon receiver in relation to the radio beacon emitter. Hence, if the radio beacon receiver and the radio beacon transmitter are too far away from each other, no action is triggered at all and consequently no energy is wasted. The predefined action triggering area defines a zone in which it makes sense to trigger an action and to allow energy consumption in the system for guiding a person towards a product. Further to this the dimension of the action-triggering area can be easily dimensioned such that the person can utilize the action to find its way towards a particular product.

In summary the invention provides two major improvements, which are reduced energy consumption in the system and enhanced picking productivity by focusing the awareness of the person searching for products.

Preferably the method is applied or used, respectively, in a product placement area, in particular in a supermarket, where products or groups or products are placed at certain positions.

In a particular embodiment of the method the radio beacon receiver is locally movable with a person, who carries it around in the product placement area. It may also be locally movable with a device, to which it is attached or in which it is embedded, for example a shopping trolley that is moved by a person.

The assignment of the radio beacon emitter to a product may be given by the fact that the radio beacon emitter is logically linked/bound to the product either by itself (directly) or via another device (indirectly) that is directly linked/bound to the product and that carries or comprises the radio beacon emitter. This logic link is stored by data, e.g. in a data base.

Further particularly advantageous embodiments and extensions of the invention arise from the dependent claims and the following description.

In general, a business premises such as a supermarket, warehouse, or the like, where the method is applicable, may comprise a smaller or larger number of electronic display devices. The number of installed display devices may depend on the size of the supermarket and/or the number of products or product groups.

Such electronic display devices may be realized as so-called electronic shelf labels (ESL) which are installed on shelf rails at positions along the shelf rail in proximity to the product groups or products with which they are logically linked. They typically comprise a low- or close-to-zero-power consuming display screen (e.g. realizes by electronic paper or electrophoretic technology) to show product and/or price information for said product groups or products. The content that is shown by the display is provided by the content data which are sent to the ESLs either by radio signals or wire-based and typically convey text(s) and/or image(s) which are in turn displayed by the display.

Such electronic display devices may also be realized as so termed video rails, which comprise one or more video screens that are installed on (or along) a shelf rail or form the shelf rail by itself. In contrast to the ESLs the video rails comprise a video display screen and therefore can display videos and/or virtual electronic shelf labels. The virtual electronic shelf labels may be freely positioned along the display of the video rail and may also overlap the video or are embedded therein. Again, said content data are provided to the video rail to convey the video and/or virtual electronic label, which are in turn displayed by the display.

Such electronic display devices may also be realized as smart posters, which allow for a situation specific display of content on its display screen.

The content data are generated and provided by the data provision system. The data provision system may be realized by a cloud based (software and hardware) service or by a local server in the premises of the supermarket, wherein in both cases a software is executed on the respective computer architecture which processes human readably text(s) or picture(s) that is content to be displayed by the respective electronic display device. The processing leads to the content data, which are coded in the appropriate data format, and which are supplied to the electronic display devices.

Typically, the data provision system is connected to a communication network within the premises of a supermarket, which is designed to deliver the content data either by radio signals or by wires to the respective electronic display device. Such a communication network may comprise radio access points, of which each is designed to perform a radio communication with a group of electronic display devices. Such a communication network may also comprise routers or controllers and the like, to which the electronic display devices are connected, preferably in groups.

The data provision system typically comprises a shop management software that maintains a data base which stores a plan of the entire shop, the shelfs, the products on the shelfs and the electronic shelf labels linked to the respective product. Such a data structure is commonly known as planogram. Hence the data provision system allows to address each individual electronic display device to display individual content, which was automatically generated or defined by an authorized user of the display system.

The data provision system may further comprise one or more (portable or stationary) computer-based input devices which allow the authorized user of the display system to select or to define the human readably text(s) or picture(s) which is intended to be displayed by one of the electronic display devices or a group of the electronic display devices. Such an input device may be a for example, a computer terminal, a personal digital assistant, a mobile phone, a tablet computer etc. Theses input devices execute a user interface software on their computer hardware, which is programmed to allows the user to perfume the appropriate user interaction for the selection or the definition of the human readably text(s) or picture(s) and to interface with the shop management software. The input devices further comprise the hard- and software needed to supply a representation of the human readably text(s) or picture(s) in digital form, e.g. in an intermediate data format or as the content data to the data provision system.

Further to this, such portable devices may be used by the authorized user, which in the present context is termed “order picker” to collect products in accordance with an order received by a customer. In the following the different aspects of the order picking processed are elaborated in detail. However, it is highlighted that the method of guiding a person to products in a product placement area where products are placed may also be applied in the context of a customer who walks through a supermarket and collects the products in accordance with his/her shopping list. In this context the portable device of the customer may be a smart phone or a table computer or the like, which the customer carries with her/him.

As explained, in the preferred use case of the invention the person guided by the method according to the invention is an order picker. In this context the radio beacon receiver is an electronic mobile device of the order picker that comprises a display-screen and displays product information of a product or a list of products to be picked by the order picker. This product information or this product list or list of product information can be entered or uploaded directly into the mobile device for this purpose. Each mobile device of the group of order pickers may receive the respective data from the data provision system that provides a shopping application which supports the order pick and collect process, such that each order picker can handle individual orders of customers. The respective data can be pushed to the mobile device(s) or the mobile device(s) may automatically sync with the shopping application.

Such an electronic mobile device can be realized by one of the following elements that comprises a radio beacon receiver stage which receives the radio beacon:
a Personal Digital Assistant (PDA),
a smart phone,
a tablet computer,
a smart watch
a smart trolley.

These elements can be adapted on the software side and/or on the hardware side for the task of order picking, which means that the computer of such devices executes an order picking application which provides features on the side of the mobile deice which are necessary to the order picker. These mobile devices also comprise the radio receiver electronics to receive the radio beacon and to extract and utilize and/or further process a radio beacon data content which is conveyed by the radio beacon.

The radio beacon emitter can be realized by at least one of the following elements that comprises a radio beacon emitting stage which emits the radio beacon:
an electronic shelf label. The electronic shelf label is typically attached to a shelf, in particular to a shelf rail which limits a shelf floor where products can be placed. Such shelf labels can also be designed as table displays or as clothing tags.
a rail to which shelf labels or other devices are attachable. This means that the shelf rail itself or the (front) rail of a product presentation table can comprise the electronics of the radio beacon emitting stage.
an electronic rail-controller, which is designed to control a number of electronic shelf labels or other electronic devices that are attached to the rail of the rail-controller. In this embodiment the electronics of the radio beacon emitting stage is embedded into the rail-controller so to say at a central location in the rail. Hence the ESLs that are controlled by the rail-controller do not require any additional electronics to realize the radio beacon emitting stage.
an electronic label that is attached to a product. In this embodiment the electronic label may be realized as a Radio Identification Tag (RFID-Tag) or as a Near-Field-Communication-Device (NFC-Device), which may primarily be used to identify products. Its functionality is now enriched by the radio beacon emitting stage which makes it suitable for the method according to the invention.

The purpose of the action is to make the order picker aware of her/his proximity to at least one of the products on the shopping list. Hence, it is of advantage that the action can be characterized by at least one of the following measures (see below) which is realized in the spatial proximity of the product or the intended place of the product and/or which is locally movable with the person.

Hence, according to a first aspect of this feature the action is performed by an electronic device that is located in (close) proximity of the product (e.g. by an ESL or a rail-controller, a rail or an RFID or NFC tag attached to the product). According to a second aspect of this feature the action is performed by an electronic device that is locally movable with the order picker (e.g. a PDA, a tablet computer, a smart phone, etc.). And according to a third aspect of this feature the action may be performed, in particular simultaneously, by the electronic device that is located in (close) proximity of the product (see “first aspect of this feature”) and by an electronic device that is locally movable with the order picker (see “second aspect of this feature”). The “following measures” as indicated above are listed herein as follows:
change a humanly readable content displayed on a display screen, in particular picking information. For example, the order number, the product number, the product name or a note such as “here” or “close to you” can be displayed to the person.
show a visual effect on a display screen. For example, the display screen can flash or change its content quickly in order to dynamically alter its appearance and draw attention to itself.
show a visual effect by the aid of a light source. For example, an LED can be provided that flashes or lights up or changes its color. The LED may be provided either on the locally movable electronic device or on the electronic device that is located in (close) proximity of the product.
perform a vibration by the aid of a vibration stage: This makes it possible to inform the order picker that the action-triggering area has been reached without the person having to take their eyes off their current activity. The separation of the action from the visual content to be reviewed for the purpose of the collection of products enhances the performance of the order picker because the order picker can continue to review the list of products visually undisturbed while e.g. her/his PDA vibrates. Further to this, no other person, be it a customer or another order picker is disturbed by the action.
release an acoustic signal by the aid of an acoustic signal generator stage. Also, acoustic signals provide the advantage that this action is separated from the visual content to be reviewed by the order picker for the purpose of the collection of products and therefore also enhances the performance of the order picker because the order picker can continue to review the list of products visually undisturbed while e.g. her/his PDA emits a sound. The sound can of course also be perceived by other people in the vicinity of the electronic device that emits the sound. So that different order pickers do not disturb each other, each order picker can be assigned a different tone.

The action triggering area can be predefined by the radio beacon signal strength set at the radio beacon emitter and/or by a predefined threshold of a reception signal parameter, wherein the reception signal parameter describes the radio beacon received at the radio beacon receiver, and the predefined threshold is set by the radio beacon receiver.

If the radio beacon signal strength is set by the radio beacon emitter, the action triggering area is basically defined by the radio beacon emitter. The action triggering area is such an area in which the radio beacon can be reliably received by the radio beacon receiver. The radio signal strength is basically set by the radio signal power used to emit the radio beacon, which determines the maximum distance measured from the radio emitter in which the radio beacon can be received and processed. In some embodiments a variable or adaptable radio signal strength may be used on the side of the radio beacon emitter to model or vary the action triggering area.

If the predefined threshold of the reception signal parameter is set by the radio beacon receiver, the action triggering area is basically defined by the radio beacon receiver. The reception signal parameter is derived from the received radio beacon signal. This may typically be performed by the radio beacon receiver itself, wherein e.g. the reception quality or the so termed received signal strength indicator (RSSI, power level in milliwatts or decibels referenced to one milliwatt (dBm)) is computed by the receiver electronics. The radio signal emitter can therefore define a level or value of this parameter as the predefined threshold for this parameter. In this embodiment the action triggering area can be defined to be narrower than the maximum distance between the distance measured from the radio emitter in which the radio beacon can be received and processed. It may also be used to modify or vary the width of the action triggering area during operation for various reasons on the side of the radio beacon receiver. It also allows to flexibly adjust the width of the action triggering area.

Also, a combination of both features may be applied to model the action triggering area.

Furthermore it is of advantage that the triggering of the action is dependent on the change of the signal parameter that is used to describe the received radio beacon.

On the one hand, this feature allows to take different position of the radio signal receiver within the action triggering area into account when a decision has to be made whether an action shall be triggered or not. For example, different actions can be triggered when the order picker is closer to the product than when she/he is further away.

On the other hand, this feature allows to take the movement dynamic of the radio signal receiver into account when a decision has to be made whether an action shall be triggered or not. Typically, the movement dynamics of the radio signal receiver is given by the movement of the order picker who carries the radio beacon receiver with her/him, which maps into a temporal change in the signal parameter. For example, different actions can be triggered when the order picker approaches the product than when he moves away from the product.

In some embodiments the radio signal receiver may be designed to trigger, for example, an action on an ESL, which hosts der radio beacon emitter from which the radio beacon was transmitted and received by the radio beacon receiver. This would require a particular technical solution in which the radio beacon emitter and the ESL may directly communicate with each other.

However, according to an aspect of the invention the radio beacon receiver sends data content of the received radio beacon to a, in particular central, control stage and based on the data content the control stage identifies the respective radio beacon emitter which has emitted the data content by the radio beacon and triggers the action in relation to the identified radio beacon emitter. As the control stage knows all the relation between the products, the ESLs and the radio beacon emitters in a shop and the control stage controls the content displayed by the ESLs and also the behavior of the ESLs, it can address a particular ESL based on the received data content to perform an action. In this example the action that is triggered may be the flashing of only that ESLs screen or an LED of the ESL from where the data content origins.

The—for example central—content stage may be realized by the data provision system.

Here it is of advantage that the control stage stores a data structure which links a particular product with a particular radio beacon emitter. If the radio beacon emitter is embedded, for example, in the ESL, also the logic link between the identification data of the radio beacon emitter and the ESL is stored by the central control stage and therefor the particular product which is linked to the particular ESL is also linked to the radio beacon emitted by the radio beacon emitter of the ESL.

Hence, according to another aspect of the invention the control stage triggers the action in relation to the radio beacon receiver from which it has received the data content. This feature allows to trigger an action on the mobile device of the order picker, which in particular may be used to trigger an action that is personalized for her/him.

The triggered action may be pending as long as no confirmation of task completion is received from the order picker. This may lead to a long-lasting energy consumption. Therefore, it is of advantage that the triggered action is terminated if the radio beacon receiver is moved out of the predefined action-triggering area. This makes it possible to stop the action depending on the movement of the order picker, regardless of whether the task is completed or not. A task can therefore still remain open, but the energy-consuming action is ended within a limited period of time, namely as soon as the order picker leaves the action trigger area.

However, according to a further aspect of the invention the triggered action is terminated if a termination signal is received. Such termination signal may be received from the order picker via the mobile device of the order picker or directly at the ESLs, for example by means of an NFC communication with the order picker's device.

As discussed, multiple radio beacon emitter and radio beacon receiver can be provided, and multiple different actions can be triggered. This method can be implemented in practice, for example, as follows: A picker pushes a smart trolley with a radio beacon receiver stage through the aisles of a business premises. He wears a smartwatch that also has a radio beacon receiver stage. In this example, both the smart trolley and the smart watch each form a radio beacon receiver stage. The radio beacon emitter can be implemented here as an ESL with an LED. If the order picker approaches the ESL that is assigned to one of the products he/she is looking for and enters the action triggering area, first actions can be triggered. These actions can include that both the smart trolley and the smartwatch display a text that indicates that the product is nearby. At the same time, a signal can be transmitted to the server or the data provision system, which triggers actions on the ESL side. These actions can include the ESL displaying a text and the LED flashing. If the order picker continues to approach the product or the radio beacon emitter, the smart watch begins to vibrate. The strength of the vibration or the frequency of the vibration increases as the distance to the product decreases. This means that the order picker can feel where the product is located without having to look for it. If the order picker puts the product in the shopping cart in this example, this can be automatically recognized by the shopping cart via pattern recognition or an NFC interface or reading a QR code. The actions that were triggered to lead the order picker to the product are then deactivated. It should be mentioned again that this is only an example of how the measures can be combined. Other combinations are possible.

In general, the radio beacon used in the context of this invention can be any radio signal that conveys the information discussed herein. In a preferred embodiment, the radio beacon used is a Blue Tooth radio beacon. In a more preferred embodiment, the radio beacon used is a Blue Tooth Low Energy radio beacon. Hence, the devices used to transmit and receive the radio beacon are designed in accordance to the type of radio beacon the are intended to produce.

Finally, it is to mention that electronic devices mentioned in the description of this patent application may be realized by the aid of well-known discreet and/or integrated electronics. Provided that interfaces are required the person skilled in the art will be able to select and design the appropriate interface-circuitry to enable data and/or signal communication. Programmable devices may comprise a microprocessor and some peripheral electronics. Such programmable devices may also be realized by the aid of a microcontroller or an application specific intergraded circuit (ASIC) and the like. Execution of software routines on such devices provides computer implemented functions that are discussed herein.

These and other aspects of the invention are obtained from the figures discussed below.

### BRIEF DESCRIPTION OF THE FIGURES

The invention is explained again hereafter with reference to the attached figures and on the basis of exemplary embodiments, which nevertheless do not limit the scope of the invention. In the different figures the same components are labelled with identical reference numbers. They show in schematic fashion in:

FIG. 1 an electronic shelf label system used to guide an order picker by the aid of a mobile device;

FIG. 2 a block diagram of an electronic shelf label used in the system;

FIG. 3 a block diagram of a mobile device used in the system;

FIG. 4 a section of a floor plan of a shelf arrangement in a shop;

FIG. 5 a view along a shelf aisle, in which the mobile device is moved by the shop picker.

### DESCRIPTION OF THE EXEMPLARY EMBODIMENTS

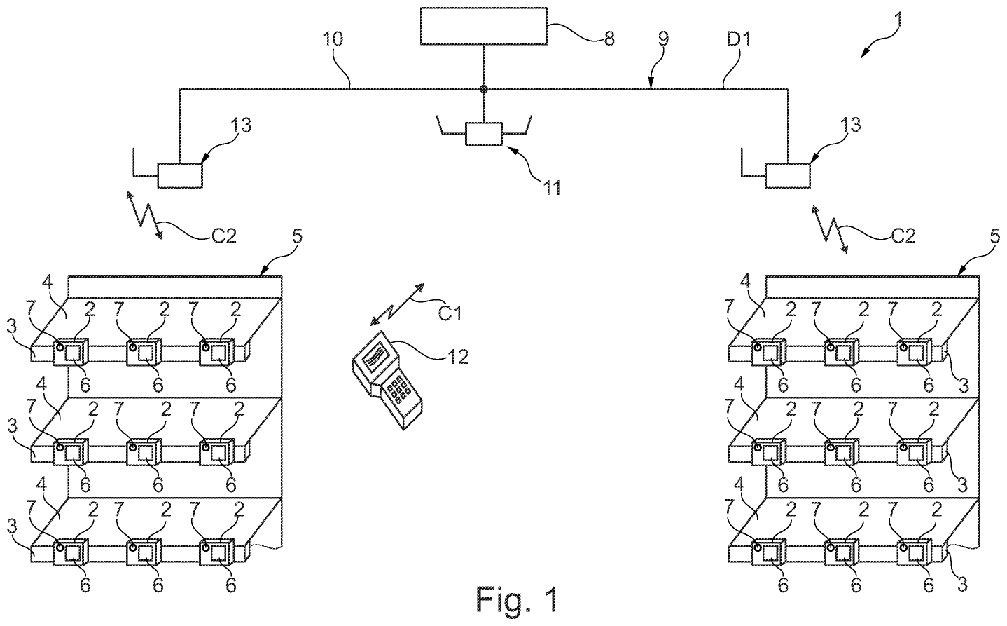

FIG. 1 visualizes a basic concept of an electronic shelf label display system 1 (abbreviated herein as system 1), which is installed in the premises of a supermarket. The system comprises a number of electronic shelf labels 2 (abbreviated herein as ESL 2). The ESL 2 are installed on shelf rails 3 (abbreviated herein as rails 3). The rails 3 are located at the front edge of a shelf floors 4 of shelfs 5.

The shelf floors 4 are used to present products, which for the sake of simplicity of the figures are not shown.

The ESLs 2 are used to display product information and price information of products for a customer which picks the products by himself/herself, possibly with the help of a digital purchase. However, in particular the product information is also used by an order- or store-picker to pick products according to an order defined by a customer who doesn't want to pick the products by himself/herself. The information that can be humanly read is displayed by a display screen 6 of the ESLs 2. The ESLs 2 further comprises a light emitting diode 7 (abbreviated as LED 7) to emit a light signal which can be humanly perceived. The LED 7 is used to draw attention of a customer or the order picker to the respective ESL 2 when the light signal is emitted. Hence, it can be used to guide the customer or the order picker towards the respective ESL 2 in order to find a particular product to which the respective ESL 2 is logically bound. In contrast to the ESL's display screen 6, from which the information displayed is only really easy to read when the display screen 6 is viewed from the front, the flashing of the LED 7 can also be clearly perceived by looking at the relevant ESL 2 from the side. This means that the blinking of the LED 7 can also be perceived perfectly when looking along the shelf aisles and therefore the LED 7 is the preferred element to guide the customer or the order-picker from a distance to the product in question. The good visibility of the light signal emitted by the LED 7 is improved by a light guide. The light guide surrounds the LED 7 and is designed to deflect the light emitted by the LED 7 to the side. This light guide protrudes over the surface of the display screen 6 in order to improve the lateral visibility of the light emitted. The light guide is not shown in detail in the figures.

In this exemplary embodiment, the ESL 2 also takes on the task of the radio beacon emitter.

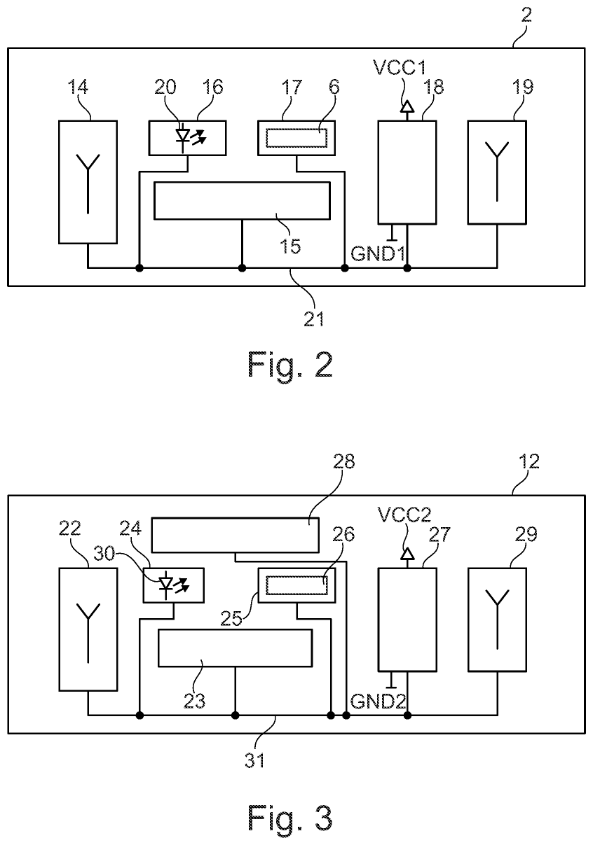

FIG. 1 further shows a data provision system to provide content data D1 over a communication network 9 to the ESLs 2, so that the ESLs 2 can display the information conveyed by the content data D1. In the present case the data provisioning system is a server 8 that runs the required shop management software application(s) and is located in the back office or a separate server room (not shown) of the supermarket. The server 8 is therefore designed to act as a control stage. The communication network 9 comprises a wire-based local area network (abbreviated herein as LAN 10) that connects the server 8 with a wireless local area network access point (abbreviated herein as WLAN-AP 11) which is used to communicate with a mobile device 12. In this example, the mobile device 12 is also the radio beacon receiver and contains the corresponding components for it, as will be explained below. The mobile device 12 is a sort of a personal digital assistant used by the employees of the supermarket to establish a binding between a product and an ESL 2. In this process a barcode on the product or its packaging, which is the EAN-code of the product, is canned and also the identification code of the ESL 2 displayed on its display screen 6 is scanned by a barcode scanner module (see FIG. 3) of the mobile device 12. Thereafter the mobile device 12 communicates the scanned codes via a WLAN-communication C1 with the WLAN-AP 11 to the server 8 where a data structure is created that stores the logic link between the ESLs 2 in the shop and the products presented in the shop. Upfront to this the ESLs 2 installed in the shop were initially registered with the server 8 so that they are ready to be used in the shop. Also position information may be supplied by the mobile device 12 so that the planogram of the shop can be complete and stored by the server 8 in the data structure.

In this exemplary embodiment, the mobile device 12 comprises a display screen 28 in order to display human-readable content, in particular product information and/or position information.

FIG. 1 also shows two electronic shelf label access points (each is herein abbreviated as ESL-AP 13), which are used for the server 8 to communicate with the ESLs 2 in an ESL-communication C2 so to supply the content data D1 to the ESLs 2 and/or to set certain operation parameters or to receive or request certain operation conditions from the ESLs 2. The ESLs 2 and the ESL-AP 13 are designed to utilize an ESL-communication protocol that is typically different from the protocol used in the WLAN-communication C1. Some examples for such an ESL-communication protocols are ZigBee or a proprietary time-slot-communication protocol of the applicant that is disclosed in the published PCT patent application WO2015/124197A1, page 2-22, which is herewith incorporate by reference. Here each of the ESL-AP 13 can serve several ESLs 2 which have been registered at the respective ESL-AP 2. Here the ESLs 2 installed on the shelf 5 located in the right half of the FIG. 1 are assigned to the ESL-AP 13 shown directly above this shelf 5 and the ESL 2 installed on the shelf 5 on the left side of the Figure are assigned to the ESL-AP 13 shown directly above this shelf 5. The two ESL-APs 13 are operated in different radio channels and avoid the use of the radio channel occupied by the WLAN-AP 11 to guarantee proper radio communication with the ESLs 2.

In the following a block diagram of the electronics of the ESL 2 is shown in FIG. 2.

The ESL 2 comprises an ESL-radio-module 14 which is designed to perform the ESL-communication C2. It typically comprises a conventional transceiver circuit that is connected to a conventional antenna circuit. The ESL 2 also comprises an ESL controller 15 which controls the communication via the ESL-radio-module 14 and other modules, like a first LED-module 16, a first display module 17, a first battery module 18 and a radio beacon emitter stage 19. The battery module 18 serves as power supply of the ESL 2 and provides a first supply voltage VCC1 against a reference potential GND1. The display module 17 comprises the display screen 6 and the electronics to drive the display screen 6 so to display the information conveyed by the content data D1. The display module 17 may also comprise a separate controller (not shown) to control the operation of the display screen 6. The LED-module 16 comprises at least one LED 7 and the electronics to drive the LED 7 under the control of the ESL 2 controller 15. The radio beacon emitter stage 19 comprises a radio signal transmitter electronics that is coupled to an antenna circuit, both are conventional circuits and therefore are not shown in detail in the FIG. 2. The radio beacon emitter stage 19 is designed to send out a radio beacon that conveys as data content a unique identification code to individually identify the respective ESL 2 from which the radio beacon was sent out. The logic link between the respective ESL 2 and unique identification code is stored in the mentioned data structure. In the simplest form the data content may be the unique identification code of the ESLs 2 which was already used to bind the ESL 2 with a product. The electronic modules of the ESL 2 are coupled by a first (data/signal) bus 21.

In the following a block diagram of the electronics of the mobile device 12 is show in FIG. 3. The mobile device 12 comprises 12 comprises an WLAN-radio-module 22 which is designed to perform the WLAN-communication C2. It typically comprises a conventional transceiver circuit that is connected to a conventional antenna circuit. The mobile device 12 also comprises a mobile device controller 23 which controls the communication via the WLAN-radio-module 22 and other modules, like a second LED-module 24, a second display module 25 that may comprise a conventional LCD display 26, a second battery module 27, the already mentioned barcode scanner module 28, and a radio beacon receiver stage 29. The LED-module 24 comprises at least one further LED 30, which is use under the control of the mobile device controller 23 to emit a light signal to trigger the attention of the user (employee/order picker). The display module 25 is used under the control of the mobile device controller 23 to display instructions, in particular a shopping list or elements of a shopping list for the order picker. The radio beacon receiver stage 29 is designed to receive the radio beacon sent out by the ESLs 2 and to deliver its data content to the mobile device controller 23 from where it is communicated via the WLAN-radio-module 22 in a WLAN-communication C1 to the server 8. The electronic modules of the mobile device 12 are coupled by a second (data/signal) bus 31.

The data content received at the server 8 allows the server 8 to determine that the mobile device 12 has entered a reception zone around the ESLs 2 from which the respective radio beacon was sent out. As the positions of the individual ESLs 2 are known to the server 8 because it stores and manages the planogram, the server 8 also knows that the mobile device 12 must be within a certain area around the respective ESLs 2 from where the received data content origins.

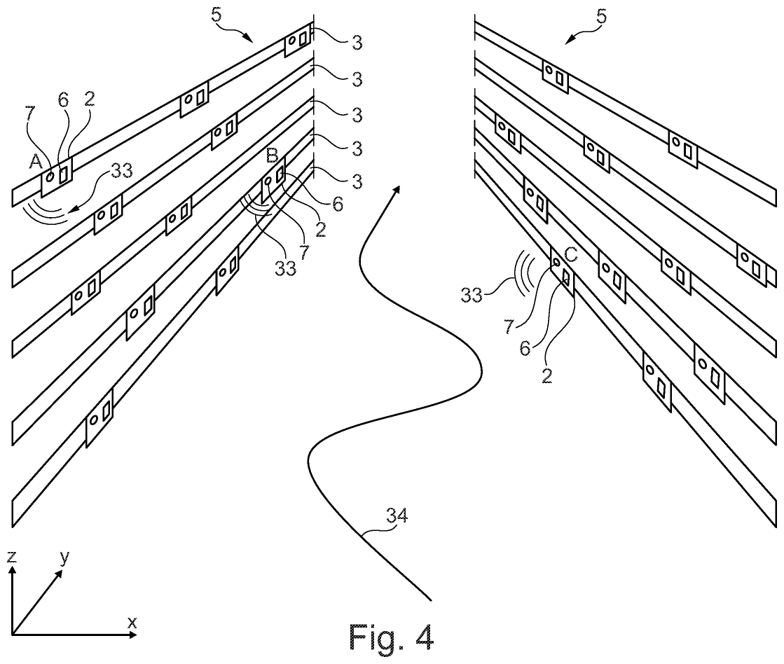

In the following a method of guiding an order picker is explained with reference to FIG. 4. In FIG. 4 the two shelfs 5 are indicated, of which for simplicity reasons only the rails 3 are shown, which delimit an aisle on the left and right side respectively, wherein it is assumed that the aisle has a length (e.g. 30 meters) that is significantly longer than the transmission range (e.g. 5 meters) of the radio beacon emitter stage 19 of the ESLs 2 installed at the rails 3. It is also assumed that the order picker has downloaded an order from the server 8 to his mobile device 12 and the screen 28 of the mobile device 12 displays the list of the ordered products A, B and C in a list together with the number of products A to C to be collected. When walking along the y-axis of the coordinate shown in FIG. 4, which means when moving down the aisle, the order picker carries his mobile device 12 with her/him.

Regarding the products to be collected it is assumed that these products are placed at positions A, B and C on the shelfs 5. To avoid overloading the FIG. 4 with reference signs, only the reference signs of the ESLs 2 that are bound to the products A, B and C are shown.

The mobile device 12 enters the aisle and receives the beacon signals from the radio beacon emitter stages 19 of the first ESLs 2 on the left and the right side of the aisle. The respective data content is extracted from the received radio beacons and sent to the server 8, where the ESLs 2 that is bound to the product A is identified and the identified ESL 2 is commanded by the server 8 to start flashing its LED 7 as an action, which is visualized by the sequence of lines 33. This triggers the awareness of the order picker and she/he takes the products A out of the left shelf 5. The order picker then acknowledges the order for the product A, which is transmitted to the server 8, where a command to stop the blinking of the LED 7 is sent to the ESLs 2 that is bound to Product A.

As the order picker continues his way along the shelfs 5 his mobile device 12 enters the reception area of the radio beacon sent out by the ESL 2 that is bound to the product C. According to the procedure already explained in the context of the product A also here the LED 7 of the respective ESL 2 starts blinking as an action. Because product B is listed above product C in the lists of products A-C, the order of the products in this list is now changed as an action so that product C is now put in the center of the display screen 28 instead of product B. Again, once the order for product C is acknowledged, the blinking of the LED 7 of the ESL 2 bound to the product C is terminated.

Finally, as the order picker further moves ahead down the aisle and reaches the reception area of the radio beacon of the ESL 2 bound to the product B, the respective ESL 2 is instructed by the server 8 to start blinking its LED 7 as an action until the order picker has picked the product B and acknowledged the order for product B. Thereafter the blinking of the LED 7 is stopped.

In the FIG. 4 an arrow 34 depicts the way the order picker moves along the shelfs 5 while she/he is guided by the flashing LEDs 7 toward the products A, B and C that shall be picked.

Even if in the present case the invention was only discussed on the basis of an aisle between two shelves, it should be pointed out at this point that this method can of course also be used excellently with more complex aisle or shelf structures.

It is to mention that electronic devices mentioned in the description of this patent application may be realized by the aid of well-known discreet and/or integrated electronics. Provided that interfaces are required the person skilled in the art will be able to select and design the appropriate interface-circuitry (transceivers) to enable data and/or signal communication. Programmable devices may comprise a microprocessor and some peripheral electronics. Such programmable devices may also be realized by the aid of a microcontroller or an application specific intergraded circuit (ASIC) and the like. Execution of software routines on such devices provides computer implemented functions that are discussed herein.

Finally, let it be noted once again that the figures described in detail above only involve exemplary embodiments, which the expert can modify in a wide variety of ways without departing from the area of the invention. For the sake of completeness, let it also be stated that use of the indeterminate article “a” or “an” does not mean that the respective features cannot be present multiple times.

1. A method of guiding a person to products (A, B, C), wherein the method comprises the following steps, namely:
emitting a radio beacon from a radio beacon emitter (2), which is assigned to a product (A, B, C) and is essentially located in the spatial proximity of this product (A, B, C) or the intended place of the product (A, B, C),
receiving the emitted radio beacon by a radio beacon receiver (12) which is locally movable, in particular with the person or a device,
triggering an action when the radio beacon receiver (12) is moved into a predefined action-triggering area around the radio beacon emitter (2).

2. The method according to claim 1, wherein the guided person is an order picker and the radio beacon receiver is an electronic mobile device (12) that comprises a display-screen (28) and displays product information of a product or a list of products (A, B, C) to be picked by the order picker.

3. The method according to claim 2, wherein the electronic mobile device (12) is realized by one of the following elements that comprises a radio beacon receiver stage (29) which receives the radio beacon:
a Personal Digital Assistant (12),
a smart phone,
a tablet computer,
a smartwatch
a smart trolley.

4. The method according to claim 1, wherein the radio beacon emitter (2) is realized by at least one of the following elements that comprises a radio beacon emitting stage (19) which emits the radio beacon:
an electronic shelf label (2),
a rail to which shelf labels or other devices are attachable,
an electronic rail-controller, which is designed to control a number of electronic shelf labels or other electronic devices that are attached to a rail of the rail-controller,
an electronic label that is attached to a product.

5. The method according to one claim 1, wherein the action is characterized by at least one of the following measures which is realized in the spatial proximity of this product or the intended place of the product and/or which is locally movable with the person:
change a humanly readable content displayed on a display screen, in particular picking information;
show a visual effect on a display screen;
show a visual effect by the aid of a light source;
perform a vibration by the aid of a vibration stage;
release an acoustic signal by the aid of an acoustic signal generator stage.

6. The method according to claim 1, wherein the action triggering area is predefined:
by the radio beacon signal strength set at the radio beacon emitter (2) and/or
by a predefined threshold of a reception signal parameter, wherein the signal parameter describes the radio beacon received at the radio beacon receiver (12), and the predefined threshold is set by the radio beacon receiver (12).

7. The method according to claim 1, wherein the triggering of the action is dependent on the change of the signal parameter that is used to describe the received radio beacon.

8. The method according to claim 1, wherein the radio beacon receiver (12) sends radio beacon data content of the received radio beacon to a, in particular central, control stage (8) and based on the radio beacon data content the control stage (8) identifies the respective radio beacon emitter (2) which has emitted the data content by the radio beacon and triggers the action in relation to the identified radio beacon emitter (2).

9. The method according to claim 8, wherein the control stage (8) stores a data structure which links a particular product (A, B, C) with a particular radio beacon emitter (2).

10. The method according to claim 9, wherein the control stage (8) triggers the action in relation to the radio beacon receiver (12) from which it has received the data content.

11. The method according to claim 1, wherein the triggered action is terminated if the radio beacon receiver (12) is moved out of the predefined action-triggering area.

12. The method according to claim 1, wherein the triggered action is terminated if a termination signal is received.
